(19) United States
(12) Patent Application Publication
(10) Pub. No.: US 2019/0014749 A1
(43) Pub. Date: Jan. 17, 2019

(54) SYSTEM AND METHOD FOR EVALUATING QUALITY OF PEN RIDER ACTIVITIES IN FEEDLOT ENVIRONMENT

(71) Applicant: Taylor Consulting LLC, Wellsville, KS (US)

(72) Inventor: Garrett Taylor, Wellsville, KS (US)

(21) Appl. No.: 16/008,844

(22) Filed: Jun. 14, 2018

Related U.S. Application Data
(60) Provisional application No. 62/531,267, filed on Jul. 11, 2017.

(51) Int. Cl. A01K 29/00; G06Q 10/06

(52) U.S. Cl. CPC A01K 29/005; G06Q 10/063114; A01K 2227/101; G06Q 10/06398; G06Q 10/06393

(57) ABSTRACT

The invention includes a system and method for evaluating the quality of pen rider activities in an environment such as a feedlot. The quality of the activities relate to individual rides conducted by pen riders in a feedlot in which the rides are numerically scored. The score is a function of a plurality of measured factors that specifically correspond to the physical actions of a pen rider while occupying a pen. The measured factors may be incorporated within an algorithm for determining the numerical score. The measured factors may include the number of seconds paused within a pen, a ride length within the pen, a ride speed within the pen, the number of rotations of the rider within the pen, and combinations thereof. The quality of activities is also evaluated by visual records showing routes taken as recorded by GPS locations. User interfaces are automatically generated to show ride scores and routes taken by riders on a graphical display.

### CROSS REFERENCE TO RELATED APPPLICATIONS

This application claims the benefit of priority to US Provisional Application filed on Jul. 11, 2017, U.S. Ser. No. 62/531,267, this prior provisional application being incorporated by reference in its entirety herein.

### FIELD OF THE INVENTION

The invention relates to evaluating the efficiency and quality of services provided by personnel in a feedlot environment, and more particularly, to the efficiency and quality of pen riders who monitor and report on the status of cattle in a feedlot, and who also conduct physical actions in the feedlot to achieve the monitoring and reporting functions by riding horseback within the feedlot to evaluate feedlot animals.

### BACKGROUND OF THE INVENTION

A feedlot or feed yard is the location where cattle undergo final stages of production primarily for the purpose of weight gain. Cattle may enter a feedlot at an average of 650-700 lbs., and within 6 to 8 months, the animals may experience weight gain of up to 400 pounds. The cattle are maintained in tight quarters in order to maximize weight gain prior to slaughter. Because the cattle are relatively confined and share the close quarters with many other animals, this environment adds to the overall physical stress of the animals. Many cattle may develop ailments such as Bovine Respiratory Disease (BRD) which slow weight gain and increase the costs of production because the animals must be treated.

There are a number of patent references that disclose systems for animal management in a feedlot environment. These references provide automation in tracking animals regarding health of the animals and costs incurred in feeding and treating the animals prior to slaughter. In short, the cattle industry has become very complex in adding automation to increase animal yields and reduce costs.

One example of a U.S. patent reference includes the U.S. Pat. No. 7,870,840 entitled Cattle Management System and Method. This reference discloses an automated system for managing numerous routine and non-routine tasks for cattle production. The system incorporates a data processing system wherein comprehensive data is gathered and maintained on each individual animal as well as on selected groups of animals. Preferably, a central database is used which allows enhanced functionality with respect to data entry, data transfer, and system generated management recommendations. The system can record all monitored events that take place at each location during an animal's production cycle and can report the events and locations as required to government entities, financial institutions, and other entities within the industry.

Another U.S. patent reference disclosing management of cattle is the U.S. Pat. No. 7,748,345. This reference discloses a system for providing individual animal electronic identification, measurement and value based management of cattle in a large cattle feedlot. Through the use of (1) a computer system integrated with (2) automatic individual animal identification (3) multiple measurement and re-measurement systems with automatic data input and (4) a cattle handling and sorting system, animals are individually (a) identified and (b) measured by weight, external dimensions and characteristics of internal body tissue. With this information together with animal physiological characteristics and historical data, the computer system calculates the optimum (c) slaughter weight, (d) economic end point and (e) marketing date for shipment to a packing plant. After measurement, individual animals are (f) sorted by direction of the computer in response to calculations from the measurements. The computer system also calculates from individual animal data and other data (g) each animal's pro rata share of total feed intake for the animal's feed group. The computer system (h) stores individual animal measurement, performance and location data, which is used by management to (i) select animals for shipment from the feedlot for slaughter at the optimum time. Following an animal's shipment to a slaughter facility, its identification in the computer system is used to (j) correlate the live animal physical characteristics and performance data to the measured and evaluated carcass characteristics data obtained during the slaughter process and (k) build a data base to more accurately identify and measure value-based characteristics in subsequent animals produced and fed for more effective value-based selection and management of those animals.

Despite the clear trend in the cattle industry to provide automation at nearly every stage of cattle production, there is a clear lack of automation with respect to the analysis of how feedlot employees conduct their duties which may have an effect on the overall cost and efficiency of cattle production. Stated in another way, there is a clear lack of computerized analysis with respect to how feedlot employees conduct their duties which may be directly tied to the health of the animals while in the feedlot.

The one very important but often overlooked employee of a feedlot are pen riders. A pen rider is a person who conducts daily inspections of pens within a feedlot while on foot or horseback. Because of the confined space within a feedlot but relatively vast areas where thousands of cattle may be held, it is very difficult as well as potentially unsafe for feedlot personnel to simply walk for inspection. Additionally, it is not feasible for feedlot personnel to travel by vehicle since the sound and smell of the vehicles may add to increased animal anxiety as well as a vehicle not being able to successfully traverse the small spaces within many of the pens.

The general duties of a pen rider include moving cattle from pen to pen and to evaluate any health issues that the cattle may experience. The pen rider is given a protocol for reporting potentially sick cattle. Pen riders are also relied upon to reduce stress levels in a pen of cattle by conducting their duties without further stressing the animals. Accordingly, one theory of optimized pen rider duties is to encourage low stress handling to encourage the cattle to eat, drink, and otherwise interact normally within the confines of the feed yard. This theory also involves some degree of animal training in which the pen riders can train or condition the animals to more quickly reduce panic and confusion. The benefits of this theory in practice is that it may be a more efficient way to identify early “pulls” which are those animals that exhibit physical signs indicating health issues.

Considering the commercial realities of cattle production which require substantial resources and manpower, there is a need to provide a predictive system and method for evaluating the activities of feedlot employees as their activities affect efficient and cost effective cattle production. There is a need to provide this system and method without overburdening the feedlot employees as to greater reporting requirements or other additional duties. There is also a need to provide this system and method which takes advantage of some existing feedlot technology such as existing computer processor systems which can store and manipulate data for purposes of generating predictive outputs that indicate how effective or efficient the activities of the employee have been performed.

### SUMMARY OF THE INVENTION

In preferred embodiments of the invention, it includes a system and method for evaluating the quality of pen rider activities in an environment such as a feedlot. The quality of the activities more specifically relates to individual rides conducted by pen riders in a feedlot in which the rides are numerically scored. The score is a function of a plurality of measured factors that specifically correspond to the physical actions of a pen rider while occupying a pen.

The physical actions of a rider are recorded by use of a handheld GPS device in which recorded data is later downloaded from the GPS device. The recorded data includes time and position “stamps” which provide specific information as to the movement of a pen rider while in each pen.

After a pen rider has completed his/her pen rider duties, the data is downloaded to a computer processor system which applies one or more algorithms to generate a score for the pen rider's activities. Scores can be incrementally separated or broken down into desired portions of the pen rider's activities for the workday. For example, there may be one general group or type of pens that are of specific interest and accordingly, data can be selectively downloaded for those selected pens to determine a pen rider score. Alternatively, a pen rider's activity can be captured within a single score for the day's work of the pen rider as he/she makes their horseback rounds through the feedlot.

According to the present invention, there are some general attributes that contribute to a better pen rider score. Accordingly, within the measured factors, the specific physical actions of a pen rider can be scored higher or lower depending upon whether the more favorable attributes are effectively executed. These attributes which are defined within the factors correspond to measured physical actions of the pen rider, as explained in further detail.

According to the invention, one algorithm that can be used to determine a pen rider score includes the numerical sum of four measured factors. These factors include a seconds paused score, a ride length score, a ride speed score, and a rotation score.

The resulting scores for a given day and location, or the resulting scores for a selected portion(s) of a given day and location may be scaled, such as between 0 to 5. In this example, 5 would represent the highest score and 0 would represent the lowest score.

The four measured factors may be further defined as follows: (1) the seconds paused score may represent the number of seconds paused (that is, no movement within a pen) with 20 seconds being the maximum number of seconds that is accounted for. Thus, if a pen rider pauses for more than 20 seconds in a pen, then a default value of 20 is assigned. If the pen rider pauses for less than 20 seconds, then the actual seconds paused is assigned. The seconds paused (either actual or maximum of 20) is then divided by 20 resulting in the seconds paused score having a maximum numeric value of 1; (2) the ride length score may represent the ride length divided by 80% of the pen perimeter , and the resultant value of this expression being multiplied by 2; (3) the ride speed score may represent the difference between the number of seconds in a pen minus the number of seconds paused then divided by the sum of the ride length plus an adjustment factor of 1.25; and (4) the rotation score may represent the number of rotations executed per pen (with 10 rotations being the maximum number of rotations awarded) minus 3, this difference then divided by 7, and this resulting expression then multiplied by 2.

The numeric expressions for these measured factors are set forth below:

$$Seconds paused score = \frac{( seconds paused )}{20}$$

As mentioned, 20 seconds is the maximum amount of time rewardable in the numerator of this expression. The 20 seconds maximum in the numerator and the denominator of 20 scales the seconds paused for a numerical value between 0 and 1.

$$Ride length score = 2 * \frac{ride length}{pen perimeter * 0.8}$$

The number two is a scaling factor to give the ride length score an appropriate magnitude relative to the other scores. As compared with the seconds paused score, the ride length score is therefore given greater weight or emphasis because of the scaling factor. The constant 0.8 removes an approximation of the minimum distance needed to ride in to and out of a pen from the pen perimeter.

$$Ride speed score = \frac{seconds in pen - seconds paused}{ride length} + 1.25$$

The constant 1.25 is a scaling factor to give the ride speed score an appropriate magnitude relative to the other scores. In this case, the ride speed score is therefore given slightly greater weight/emphasis than the seconds paused score, but less weight/emphasis than the ride length score.

$$Rotation score = 2 * \frac{( number of rotations ) - 3}{7}$$

As mentioned, the maximum number of rotations awarded per pen is 10 rotations. If fewer than 3 rotations are executed, then the rotation score may have a negative value. From this rotation score equation, it can be seen that the constants 3 and 10 represent the minimum and maximum rewardable rotations. The constant 7 represents the range and scales the numerical value between −0.86 and 1. The constant 2 is a scaling factor to give the rotation score an appropriate magnitude relative to the other scores. Accordingly, the rotation score is given greater weight/emphasis than the other scores except the ride length score. Further, if there are not at least 3 rotations, a pen rider can be penalized to a greater extent because the rotation score will have a negative value.

The ride length is the sum of the distance traveled point to point within the pen. The seconds in the pen are calculated by subtracting the last time stamp of the GPS position from the timestamp of the first GPS position in the pen. The seconds paused are calculated by adding up time between two consecutive GPS positions where the velocity is less than 0.1 m/s. The pen perimeter is determined by the sum of the distance from each corner of the pen. Rotations are calculated by summing up the changes in bearing between each pair of consecutive GPS position within a pen.

A pen ride is defined by all GPS positions within the pen boundary and which have time gaps in time that do not exceed a predetermined length of time, such as no more than 30-40 seconds apart. If any time gap between two GPS positions is longer than the predetermined gap, the next set of GPS positions will be defined as a separate ride.

The above described calculations and definitions apply to pen rides that do not contain a “pull”. A pull means an animal that is removed from the pen in which the pen rider must accompany the animal to another location, such as a hospital pen. The occurrence of a pull can be recognized by the movement of a pen rider in which the pen rider will typically traverse a relatively long distance over a relatively short period of time. This can be distinguished from rides without pulls in which the pen rider will typically conduct a pen rider route by visiting adjacent pens and not skipping a significant number of pens in between.

The ride scores are calculated and presented to the pen riders in the form of a numerical score that can be transmitted via e-mail, along with comments that may accompany the e-mail to indicate the relative strengths or weaknesses of the pen rider activities. The scores may also be made available through an interactive display, discussed in greater detail below, in which a pen rider may view the routes taken by the pen rider and the corresponding data which accumulates for each pen ride. For example, a pen rider may have a relatively strong score for a number of pen rides while the same pen rider may have a relatively weak score for other pen rides. The pen rider may be able to associate the discrepancies in the scores based upon events that occurred within the pens at the time the rides occurred. The interactive display can show and distinguish good or proficient pen rides as opposed to those pen rides that are deficient with data displayed for each pen ride. The displayed data may include each of the measured factors that correspond to the specific activities within each pen. By this very incremental and exact evaluation of each pen ride, a pen rider can make immediate corrective actions since at least four measured parameters are presented to the rider for evaluation.

The quality of activities may also be separately evaluated by visual records showing the routes taken as recorded by GPS locations. User interfaces are automatically generated to show not only ride scores but also the routes taken by riders on a graphical display. The graphical display can be, for example, an overlay of the routes taken on a satellite image or a graphical map display of the feed yard. Each rider may have a designated color or some other distinguishing feature that distinguishes each rider route displayed on the user interfaces. The visual ride routes can be evaluated to determine whether rides sufficiently covered locations where animals were present in each pen, among other factors. The ride routes can also help to explain strengths or weaknesses in ride scores since the ride routes reflect incremental position data for each pen that was ridden.

According to another aspect of the invention, in addition to the pen rider activities as recorded by a mobile GPS device, data may also be integrated with the pen rider activities including the number and location of animals within each pen. Each of the animals may include an RFID tag, and the location of each of the animals may therefore be tracked within a feedlot. Each pen rider may be further evaluated based on the number of animals within each pen that may further provide information for evaluating a particular pen ride. For example, for a pen that may contain a maximum number of animals, each of the measured factors can be further analyzed considering the number of animals in the pen in which it may be desirable to have a slightly lower pen ride speed and perhaps a higher number of bearing changes which may indicate the pen rider is being particularly deliberate in closely evaluating the animals. This full pen of animals can be compared to another pen in which there may be much fewer animals and therefore it may be possible for the pen rider to increase speed and reduce the number of bearing changes because the fewer number of animals present make it easier for the pen rider to more quickly evaluate the fewer number.

With respect to a visual display for the pen riders, it may include any visual display associated with a computing device such as a user screen or a visual display associated with a mobile communication device such as a “smart phone.” The displayed information may include the specific routes taken by the pen rider within an overlay of the feedlot showing specific pens, gates, and other physical details of the feedlot. The routes may be displayed as static or time elapsed rides. The pen rider may choose any of the pens on the user display to see the recorded data associated with the pen ride conducted in the selected pen(s). The user display may also provide a depiction of the animals within each of the pen allowing the pen rider to view how each pen ride was conducted with respect to the animals in the pen.

Regarding the equipment associated with the system and method of the invention, a pen rider will carry a handheld GPS device that has the capability to record data concerning the movement of the pen rider. Typical handheld GPS devices have predefined intervals in which the device will act as a receiver to confirm the location and bearing of the user, and these position and bearing confirmations are recorded by the GPS device. The time interval between recorded positions and bearings may be 5 or 10 seconds, and this can be adjusted based upon the type of GPS device chosen. Each time a GPS recordation occurs, it provides specific coordinates as to the location of the device at the specified time and the direction which the GPS is pointed. The numerous recorded data points within each pen can then be used to determine each of the variables within the four measured factors. The GPS device may be equipped with Bluetooth or another wireless protocol in which the recorded data can be transmitted to a computer processor system that receives and manipulates the data according to the algorithms associated with scoring the rides. Alternatively, data from the GPS device may be downloaded by connection to a computer processor system such as by a USB port.

Selected outputs can be provided to the user as mentioned to convey the ride scores and other information which are useful to the pen rider. Particular patterns can be identified as to weaknesses in the pen rider rides, and these may be specifically pointed out to the pen rider. For example, a pen rider may have relatively strong ride speed scores and rotations scores, but may have relatively weak ride length scores and seconds paused scores. Trends or patterns such as these may be graphically displayed to the pen rider and may be accompanied by text that describes recommended corrective actions.

According to another aspect of the invention, in lieu of assigning a specific numerical score to the measured factors, these measured factors can be selectively combined to generate other ways of evaluating pen rider performances. Other evaluation conclusions could include pass/fail, strong/weak, proficient/non-proficient, and others that describe how the pen writer has performed duties. Therefore, it should be understood that while the numerical scores can be generated based on the mathematical equations or algorithms associated with the measured factors, the numerical value of each of the measured parameters can be used to generate other indications of the performance of the pen rider.

Considering the above features of the invention, in one aspect, it may be considered a system for evaluating the quality of pen rider activities in an environment such as a feedlot comprising: at least one GPS device carried by a pen rider as the pen rider moves throughout the feedlot, said GPS device recording a plurality of date and time stamps indicating locations of the pen rider at corresponding times; a computer processor communicating with the GPS device to receive data from the GPS device including the recorded date and time stamps; said computer including at least one database for storing said data from said GPS device; programming instructions associated with the computer processor for determining the quality of at least one pen ride undertaken by the pen rider; said programming instructions including at least one algorithm for determining a numerical score associated with the quality of the at least one pen ride, said algorithm having at least one measured factor that corresponds to a physical action of the pen rider; and at least one user display being automatically generated as associated with the computer processor to display said numerical score for viewing by a system user.

In another aspect of the invention, it may be a method for evaluating the quality of pen rider activities in an environment such as a feedlot comprising: providing at least one GPS device carried by a pen rider as the pen rider moves throughout the feedlot; recording a plurality of date and time stamp data by said GPS device indicating locations of the pen rider at corresponding times; transferring the data to a computer processor including the recorded date and time stamps; executing programming instructions associated with the computer processor for determining the quality of at least one pen ride undertaken by the pen rider; said programming instructions including at least one algorithm for determining a numerical score associated with the quality of the at least one pen ride, said algorithm having at least one measured factor that corresponds to a physical action of the pen rider; and automatically generating an output from said computer processor including at least one user display to indicate said numerical score for viewing.

In another aspect of the invention, as a sub-combination of the system, it may be considered a user display for conveying information to a pen rider regarding recorded actions of the pen rider while conducting pen rider activities.

In yet another aspect of the invention, as another sub-combination of the system, it may be considered a sub-system including a GPS device for recording pen rider activities and a user display for conveying information to a pen rider regarding recorded actions of the pen rider while conducting pen rider activities.

In yet another aspect of the invention, it may be considered as another sub-combination, namely a GPS device for recording pen rider activities and a non-transitory computer-readable medium containing computer executable instructions executed by a processor, the instructions causing the processor to execute a method for evaluating the quality of pen rider activities in an environment such as a feedlot, wherein GPS data is downloaded from the GPS device to a database associated with the processor, the method comprising: at least one GPS device carried by a pen rider as the pen rider moves through the feedlot; instructions to record date and time stamp data by said GPS device indicating locations of the pen rider at corresponding times; instructions to transfer the date and time stamp data to the computer processor; instructions to execute programming associated with the computer processor for determining the quality of at least one pen ride undertaken by the pen rider; said programming instructions including at least one algorithm for determining a numerical score associated with the quality of the at least one pen ride, said algorithm having at least one measured factor that corresponds to a physical action of the pen rider; and instructions to automatically generate an output from said computer processor including at least one user display to indicate said numerical score for viewing by a user.

In yet another aspect of the invention, it may be considered as another sub-combination, namely, a GPS device for recording pen rider activities and a user display for conveying information to a pen rider regarding recorded actions of the pen rider while conducting pen rider activities, comprising: at least one GPS device carried by a pen rider as the pen rider moves through an environment such as a feedlot, said GPS device recording a plurality of date and time stamps indicating locations of the pen rider at corresponding times; and at least one user display automatically generated, as associated with a computer processor, to display a numerical score for viewing by a system user, the numerical score corresponding to a quality of the at least one pen ride as calculated by an algorithm processed by said computer processor, said algorithm having at least one measured factor that corresponds to a physical action of the pen rider.

Other features and advantages of the invention will become apparent by a review of the following detailed description taken with the drawing of one of the preferred embodiments.

### BRIEF DESCRIPTION OF THE DRAWINGS

FIG. 1 is a schematic diagram of a system of the invention according to one preferred embodiment;

FIG. 2 is a sample user interface showing a satellite image superimposed with pen rider routes and data displayed that identifies pen riders and information concerning the rides undertaken along with data regarding information about the pens that were ridden;

FIG. 2A is an enlarged portion of FIG. 2 showing the satellite image;

FIG. 3 is another sample user interface showing start time activity for various riders;

FIG. 4 is another sample user interface with a menu display for a user to select display options;

FIG. 5 is another sample user interface showing a “Map” option selected;

FIG. 6 is another sample user interface showing a “Pens” option selected;

FIG. 7 is another sample user interface showing a “Pulls” option selected;

FIG. 8 is another sample user interface showing an add button selected within the Pulls option;

FIG. 9 is another sample user interface showing an SOS alert corresponding to a potential emergency situation for one of the riders; and

FIG. 10 is another sample user interface showing a report generated to tabulate and summarize information regarding the performance of pen riders. The report tabulates data to include the number of head rode per pen rider, average pen rider scores, pens with no data, pens with short rides, and presumptive out of range time gaps in GPS position data.

### DETAILED DESCRIPTION

According to one preferred embodiment of the invention, it includes a data processing system for evaluating the quality of pen rider activities in an environment such as a feedlot. The activities more specifically relate to the movement of pen riders within the feedlot, typically conducted on horseback, in which rides into and out of pens within the feedlot are numerically scored to indicate the quality of the rides. This is a function of a plurality of measured factors that correspond to the physical actions of the pen rider while occupying the various pens in the feedlot.

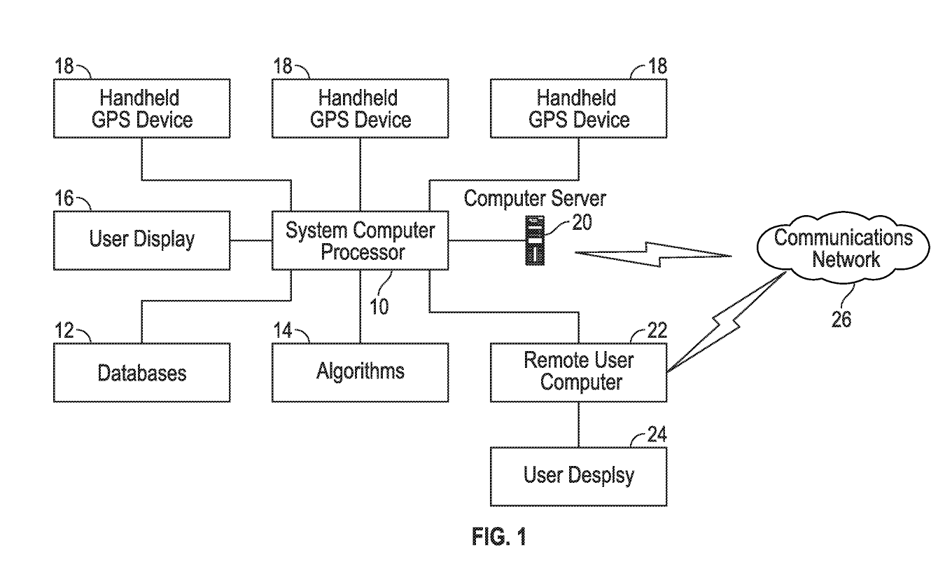

Referring to FIG. 1, one preferred embodiment of a system of the invention is shown. The data processing system includes a system computer processor 10 that is used to receive data from one or more handheld GPS devices 18 that are carried by the pen riders while conducting their feedlot duties. The physical actions of the rider are recorded by the GPS devices 18 in which the data is downloaded from the GPS devices to the system processor 10. The recorded data includes time and position data to generate the specific information regarding movement of the pen riders. The download of data may be conducted in any known data transfer protocol to include a wireless connection between the system processor and the GPS devices, a network connection, or a physical connection such as by a USB port.

The system processor 10 includes one or more databases 12 that store the collected data and making it available for processing through one or more algorithms 14 that are used to generate numerical pen rider scores, or that are used to generate other indications of the quality of the pen rider activities. The system processor may incorporate application-specific software that includes the one or more algorithms 14 in order to process the data captured, as well as to visually display results of the pen rider activities.

The system of FIG. 1 also shows a remote user computer 22 and the corresponding user displays 24 that may be used by feedlot personnel, pen riders, and others in order to access the pen rider scores and other outputs generated by the system processor to include the visual displays that may show selected data associated with the pen rider activities. A system computer server 20 is also illustrated that may be utilized to function as a central repository for data and to enable a connection between the system processor 10 and a communications network 26 such as the Internet, or other communications network such as a designated local area network. The interface between a user and the system processor 10 may be achieved through a web application in which the server 20 facilitates hosting of the application and communication through the communications network 26.

It should be understood that the system diagram of FIG. 1 is simply exemplary of one way in which to facilitate data transfer and production of user interfaces in order to evaluate the pen rider activities. According to other embodiments of the system of the invention, it may include one or more system computer processors, one or more computer servers 20, and one or more communications networks 26 depending upon the size and complexity of the feedlots that may be present in the evaluation of pen rider activities.

Further, it shall be understood that various sub combinations of the system also provide utility with respect to evaluating pen rider activities. For example, it is also contemplated that data from the handheld GPS devices may be directly downloaded to one or more system processors 10 that have their own user displays and which may be accessed by users of the system; therefore, in this sub-combination, a remote user computer, a computer server, and a communications network are not required.

As set forth above, general attributes or characteristics of the physical actions of a pen rider can be monitored and recorded to determine the quality of selected pen rides. The physical actions may be recorded as measured factors which are used within one or more algorithms to determine a numerical score corresponding to the quality of the selected pen rides.

According to one preferred embodiment, it may include an algorithm that includes the numerical sum of the four measured factors set forth above: a seconds paused score, a ride length score, a ride speed score, and a rotation score.

The numeric expressions for these measured factors are as follows:

### (1) Seconds Paused Score

$$Seconds paused score = \frac{( Seconds paused )}{20}$$

20 seconds is the maximum amount of time for the value of the numerator in this expression. The 20 seconds maximum in the numerator and the denominator of 20 scales the seconds paused score for a numerical value between 0 and 1.

### (2) Ride Length Score

$$Ride length score = 2 * \frac{ride length}{pen perimeter * 0.8}$$

The constant 2 is the scaling factor to give the ride length score an appropriate magnitude relative to the other scores. The constant 0.8 removes an approximation of the minimum distance needed to ride in to and out of a pen from the pen perimeter.

### (3) Ride Speed Score

$$Ride speed score = \frac{seconds in pen - seconds paused}{ride length} + 1.25$$

The constant 1.25 is a scaling factor to give the ride speed score an appropriate magnitude relative to the other scores.

### (4) Rotation Score

$$Rotation score = 2 * \frac{( number of rotations ) - 3}{7}$$

The constant 2 is the scaling factor to give the rotation score an appropriate magnitude relative to the other scores. The maximum number of rotations awarded per pen is 10 rotations. The constants 3 and 10 represent the minimum and maximum rewardable rotations. The constant 7 represents the range and scales the result for a numerical value between −0.86 to 1. Accordingly, if there are not at least 3 rotations, a pen rider can be penalized to a greater extent because the rotation score will have a negative value.

For the seconds paused score, this measured factor is included within the algorithm because there is some importance or significance for a pen rider to pause movement within a pen so that the rider may visually focus upon animals within the pen. An assumption is made that when the rider is not moving, this will enable the pen rider to have a better focused attention upon the animals.

For the ride length score, this measured factor is included within the algorithm because there is some importance or significance for a pen rider to travel a minimum distance within each pen indicating that the pen rider is moving to an adequate number of locations within the pen to best evaluate the status of the animals within the pen. It is possible that the animals may congregate within one single location within a pen which may not require the pen rider to traverse a significant distance within the pen; however, another assumption being made that at least some of the animals will be at different locations within the pen at any particular time.

For the ride speed score, this measured factor is included within the algorithm because there is some importance or significance for a pen rider to travel at a speed range to best evaluate the status of the animals within the pen. An excessive speed within a pen may indicate that the pen rider has not adequately evaluated the status of the animals, while a slow speed may indicate that the pen rider is spending too much time within the pen and therefore not conducting the pen rides efficiently.

For the rotation score, this measured factor is included within the algorithm because there is some importance or significance for a pen rider to change bearing or direction within a pen so that the pen rider may have an adequate number of view angles to determine the status of the animals in the pen. Particularly when the animals may huddle or bunch together within a group, it is desirable to view the animals from different directions so that there is some visual contact with each of the animals within the pen. Without at least a few directional changes within the pen, it may not be possible to view each of the animals.

It is desirable for a pen rider to physically occupy many locations within a pen to ensure that each of the animals in the pen is evaluated at relatively close range to determine their health status. Sick cattle have a tendency to migrate towards the center of a group of animals within a pen for protection, and these animals may be particular difficult to evaluate unless the pen rider is able to see these animals at close range.

Regarding the seconds paused score, 20 seconds of time is considered the maximum benefit of time spent motionless within a pen, therefore the contribution to the score is capped at 20. The logic behind this limitation or factoring is that time not spent presumably doing anything is not rewarded in pen rider scoring, as evidenced by non-movement, while encouraging some slow movement activity within the pen is rewarded.

Regarding the ride length score, most pen rides will involve at least some minimal travel into and out of a pen. The 0.8 correction factor in the denominator of the ride length score expression therefore approximates a distance roughly equal to one side of a pen. Accordingly this correction factor adjusts the overall ride length to determine what additional distance beyond moving into and out of the pen is covered by the rider.

Regarding the ride speed score, the measured distances for GPS recorded positions can be measured in meters therefore velocity may be measured in meters per second. As mentioned, the 1.25 constant in this equation can be viewed as a scaling factor that maintains the results of this calculation similarly sized to the results of the measured factors and to assign an appropriate weight or importance as compared to the other measured factors.

Regarding the rotation score, the constants 10 and 3 may be considered bounding factors for an acceptable number of rotations while the pen rider is in the pen. It has been determined that it is desirable to reward a pen rider score for anything more than three rotations but not give any additional reward for more than 10 rotations. The division by seven is used to normalize the number of rotations. The first part provides a number from −3 to 7 and so dividing by 7 provides a percentage of the maximum number of reportable rotations. As also mentioned, the constant 2 is a scaling factor to keep the results of this calculation similarly sized with the other measured factors and to assign an appropriate weight or importance as compared to the other measured factors.

According to another aspect of the invention, it shall be understood that the algorithm set forth herein is but one example of how the activities of pen riders may be recorded, quantified, and process or judged. Accordingly, other algorithms can be derived from the four measured factors, and individual factors alone may be used to generate a pen rider score. Accordingly, it should be understood that the invention is not specifically limited to the algorithm set forth herein and the invention should be viewed in a broader sense regarding how data can be captured, recorded and quantified to determine the quality of pen rider activities.

According to another aspect of the invention, in addition to data captured and processed regarding the physical activities of a pen rider, data from tagged animals within a feedlot may be combined to determine the quality of pen rider activities. RFID tags may be used within a feedlot to identify each animal therein. RFID readers may be positioned throughout the feedlot to determine the exact pen locations of each animal at any time. Similar to GPS data, time and position stamps may be associated with the reading of RFID tags by RFID readers that enable feedlot personnel to determine where each animal is located. The system and method of the invention also include an embodiment in which pen rider activities are further evaluated or judged based upon the number and location of animals within each pen as a pen rider conducts the pen rides. If there is a pen that has a larger number of animals, the measured factors may be further adjusted to account for this larger number of animals in which it may be required for the pen rider to execute a slower speed, additional time within the pen, and an increased number of rotations. If there is a pen that has a fewer number of animals, the measured factors may be further adjusted to account for this fewer number in which the rider may be able to execute a higher-speed, less time within the pen, and a reduced number of rotations. Execution of an algorithm may therefore be conditioned based upon the number of animals present within each pen such that the measured factors account for the number of animals.

Even in the absence of RFID tagged animals, a feedlot will maintain data as to the number of animals per pen at various times, and this pen data can be combined with the time and position GPS data from the pen rider activities to enable generation of measured factors that can be adjusted based on the number of animals present per pen.

Regarding generation of images which show pen rider routes within a feedlot, satellite imagery can be used to display a feedlot and then the GPS data overlaid upon the satellite imagery showing the specific routes taken by a pen rider. The satellite imagery may be enhanced by further superimposing clarified visual boundaries for each of the pens and other structures within the feedlot. Alternatively, a visual map may be provided of the feedlot which shows the specific routes taken by a pen rider. The map may show each of the pens and other structures within the feedlot.

GPS path rendering on the visual display may include color codes that indicate the identity of different pen riders that have conducted pen rides each day or over a selected period of days. This type of information may be useful to the feedlot owner who may confirm whether each pen within the feedlot has been ridden enough times or whether various pens may have been ridden too many times.

According to another aspect of the invention, pen rider activities may be contrasted against health information recorded for the animals which could include locations and times for morbidity and mortality. From a comparison between the health data and pen rider activities, there could be some correlation between the quality of the pen rides and the health status of the animals. Relatively poor quality rides for a particular pen could contribute to morbidity and mortality increases in that pen.

According to a method of the invention, pen riders are equipped with GPS devices and pen riders then execute their daily pen rides. As the pen riders travel throughout a feedlot to evaluate the animals, the GPS devices record the physical actions of the riders to include at least time and location stamps. A pen rider executes data transfer to a system processor which generates a pen rider score in which at least one algorithm is applied to numerically quantify the quality of the pen ride(s). The pen rider score(s) is provided to the pen rider. Optionally, a visual display can be provided to the pen rider that shows the specific routes taken by the pen rider. The display may include a static representation of the routes taken and/or a time lapsed visual display showing the routes taken. Preconfigured messages may also be provided to the user that includes instructions or comments on the quality of the pen rides.

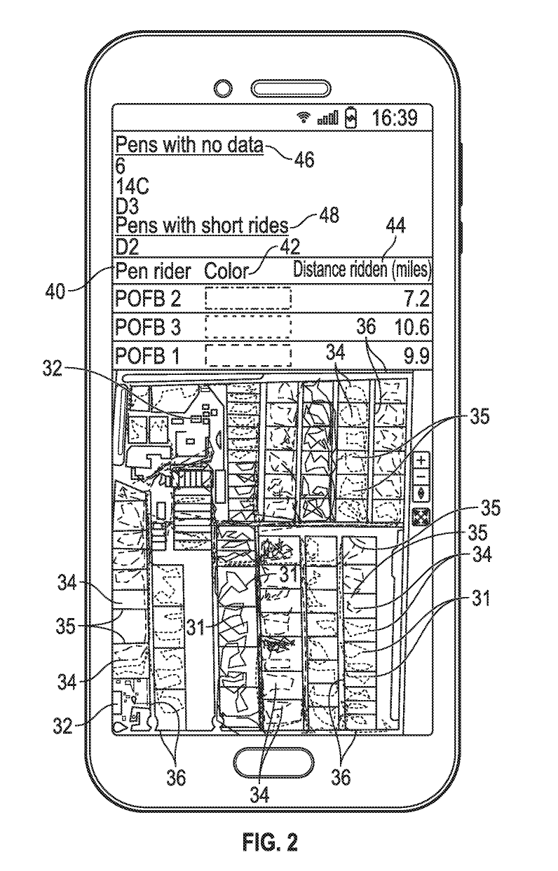

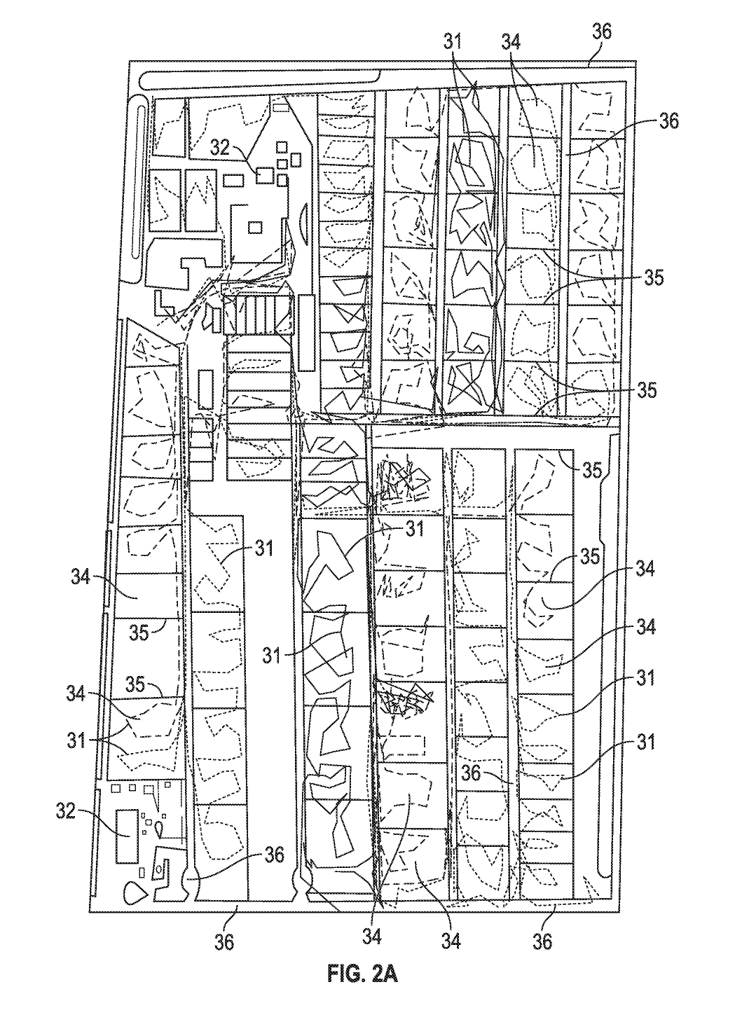

FIGS. 2-10 show a number of user interfaces or displays incorporated on a mobile communication device, such as a handheld GPS device 18, or another selected mobile user device as determined by a user of the invention. However, these user interfaces can be displayed on any selected user interface of the data processing system of the invention including, but not limited to, notebook computers, laptops, personal computers, GPS devices, mobile communication devices, and others. The users of the system may include pen rider individuals, supervisors, other feed lot personnel, or any other parties provided with user credentials. Therefore, it should be understood that the depiction of mobile devices in FIGS. 2-10 shall not limit the type of device in which the user interfaces may be observed and manipulated.

FIGS. 2 and 2A shows a sample user interface 30 that can be used to visualize pen rider activities and to determine the quality of the rides. Specifically, FIG. 2 and the enlarged portion of FIG. 2 shown in FIG. 2A includes a satellite image of a feed yard superimposed with the pen rider routes 31 taken by various pen rider individuals. The feed yard comprises a various feed yard structures 32 including buildings, feed storage bins, and others. The feed yard is divided into a plurality of pens 34 that are separated by barriers such as fences. Access to the pens 34 are provided by a network of feed yard roads or paths 36. Specifically, the barriers/fences are shown as the smaller separation lines 35 and the yard roads/paths are depicted as the larger separation lines 36. The yard roads 36 are driven by feedlot vehicles for feeding and other purposes; however, it is desirable to minimize road traffic which reduces animal anxiety, thus the reason why horses are most often used for pen riders to travel within the feed lot. The actual pen rides 31 undertaken are graphically overlaid onto the satellite image. Because of the incremental GPS data that is recorded for each ride, pen rides can be graphically illustrated as continuous lines which correspond to the actual routes taken by the pen riders. The satellite photo image is registered with GPS coordinate data which enables the pen rides to be overlaid as shown. The pen rides as between different riders can be differentiated by color for easy visual discrimination between riders on the user display. In the figure, the different pen rides 31 are depicted as different types of lines including continuous lines, broken or dashed lines, and dotted lines.

As can be seen by the superimposed pen rider routes 31, detailed visualization is provided to show how pen rider personnel conducted their rides within each pen 34. As discussed, scoring can be provided for each of the pen rides for each of the pen riders. The ability of a rider to see the actual ride routes coupled with the corresponding rider scores provide detailed feedback to rider personnel and supervisors to determine how to improve rider performance. Other data shown on the user interface 30 includes an identification of the rider 40, the matching color-coded ride routes 42, and the total distance ridden 44 for the recorded rides. Other data provided on this user interface includes a field for “Pens with no data” 46 which corresponds to those pens in which the rider(s) did not conduct a ride, or another reason as to why no data was available, such as a particular pen not having any animals therein at the time rides were being conducted. Another field shown is a listing of “Pens with short rides” 48 that indicates those pens in which a ride was undertaken, but the ride was comparatively short as measured by a predetermined pen ride length typically expected within a particular pen. A numerical comparison of the actual ride versus an expected ride length can be used to trigger an output to display the short ride in which the actual ride must be a predetermined percentage or length of the expected ride length to prevent triggering the short ride display.

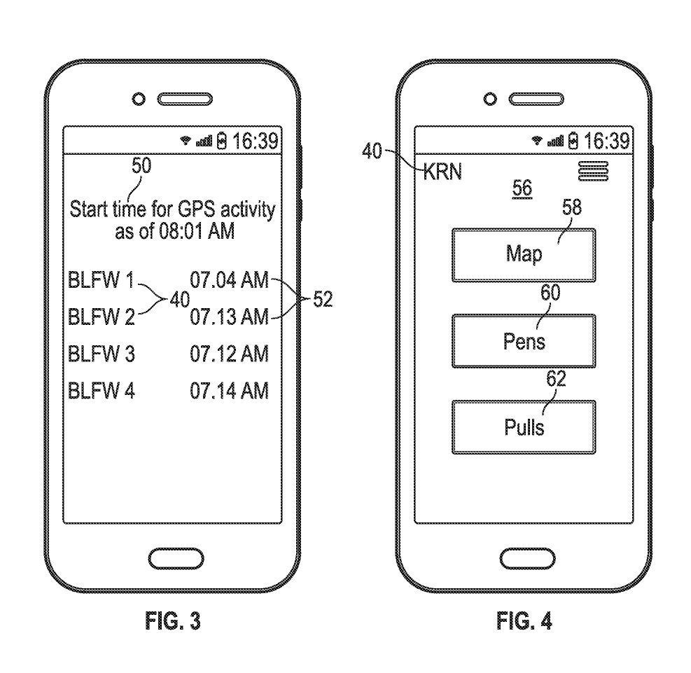

Referring to FIG. 3, another sample user interface 50 is provided showing GPS start time activities 52 for each pen rider 40. This sample user interface simple illustrates one of many other sample user interfaces that can be provided to a user to visually observe a number of parameters associated with pen rider activities.

FIG. 4 shows another sample user interface 56 associated with a specific rider 40 who undertakes pen rides, wherein the user interface provides a menu selection of additional user interfaces, namely, a Map user interface 58, a Pens user interface 60, and a Pulls user interface 62.

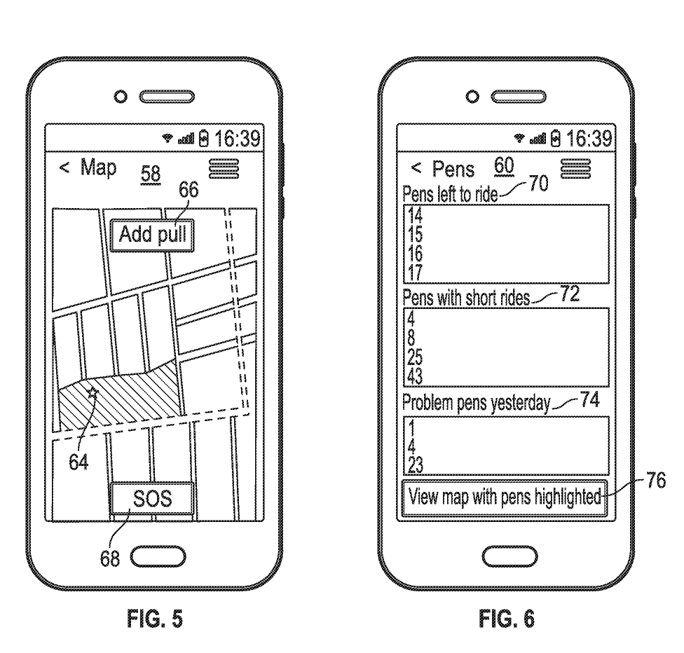

FIG. 5 shows the “Map” user interface 58 which provides the rider a map view of one or more pens that the rider is prepared to undertake a ride. The rider's specific GPS location at that time is shown as the rider icon 64. The map view orients the rider as to the rider's specific location at the time, and therefore confirms for the rider a next pen to be ridden. Two additional functions are shown on the user interface 58, namely, an Add pull button 66 which enables the rider to identify a sick or injured animal that needs to be pulled, and an SOS button 68 that indicates there is an SOS condition. The indication of the SOS condition can be visually observed by the button 68 flashing or otherwise changing state that can be easily discerned by the user along with an audible alarm.

Referring to FIG. 6, the “Pens” user interface 60 is shown which details information about pen rider activities. Specifically, this user interface 60 shows information regarding the pens that remain to be ridden 70, the number of pens with a short rides 72, and problems for pens that were ridden yesterday 74. For the pens left to ride 70, this field provides the rider a quick reference to determine which pens must still be ridden for the day. For the pens with short rides 72, this field allows the rider to re-ride those pens or to otherwise confirm that those pens do not need to be re-ridden because of some situation existing within the pens (such as no or few animals within the pen). For the problems from yesterday's pens 74, this field serves as a reminder to the pen rider to confirm whether a problem still exists within a particular pen today and whether any corrective actions need to be undertaken. Each of the pens indicated in this user interface may be separately highlighted within a map view by selecting the corresponding button 76. After selection, another user interface (not shown) is displayed with the listed pens of user interface 60 shown with highlighting. For example, the satellite image of FIG. 2 could be modified to highlight the listed pens, or a graphical map view similar to FIG. 5 could be modified to highlight the listed pens.

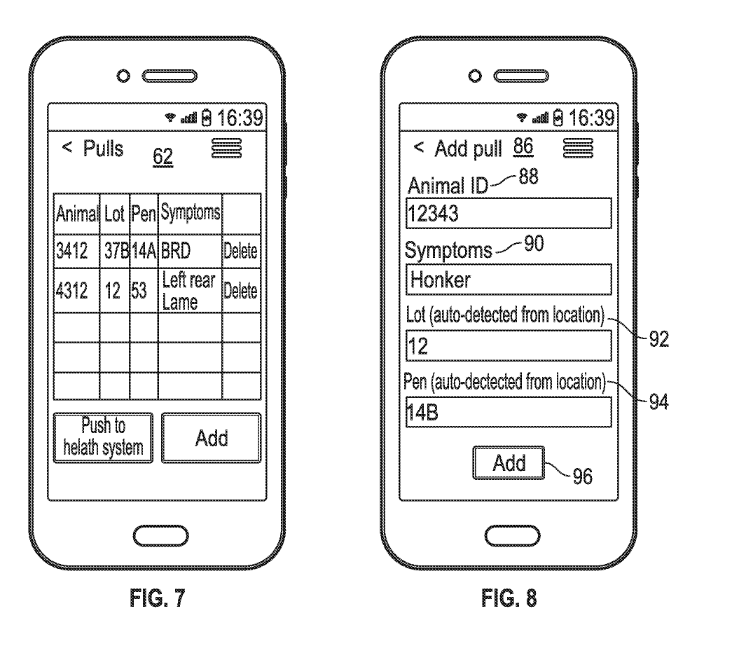

Referring to FIG. 7 the “Pulls” user interface 62 is shown. This interface details information regarding animals that have been identified to be pulled for various health reasons. The act of “pulling” the animal from a particular pen requires the rider or another person to physically separate the identified animal and accompany the animal to a hospital pen or other designated location within the feedlot where presumptively sick or injured animals can be treated. In the example of FIG. 7, animal 3412 was pulled from Lot 37 B, Pen 14 A for symptoms of BRD. The other example shown is for animal 4312 pulled from Lot 12, Pen 53, for symptoms of a lame left rear leg. Each entry may be deleted as indicated on the user interface by selecting the delete option. If an animal is to be added to the listing of pulls, the Add button 80 is selected which reveals the data entry screen of FIG. 8. At any point in time, the user may wish to forward information regarding recorded animal symptoms to the feedlot health system by highlighting a particular animal record, and then selecting the Push to health system button 82. This selection results in data transfer to the appropriate computer processor within the system to begin evaluation of the animal for treatment.

Referring to FIG. 8, this user interface 86 shows an example of data entry for an animal to be pulled. This user interface provides data fields for the pen rider to enter the particular animal ID 88, the symptoms 90, the lot 92, and the pen 94. As noted in the user interface, the particular lot and pen can be predefined from GPS data. Regarding symptoms, the user could either manually enter the symptoms, or could choose from a corresponding pulldown menu (not shown). Once the user is satisfied that the proper information has been entered for the animal to be pulled, the Add button 96 is selected which records the pull.

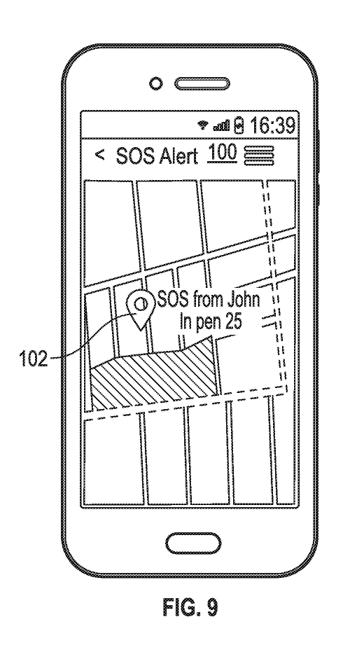

Referring to FIG. 9, this user interface 100 is provided to visually indicate the location of the individual who is associated with an SOS alert. In the example of FIG. 9, a map view is shown of the location where the individual is presently located along with the identity of the pen rider. The SOS alert condition can be automatically detected such as by lack of movement of a pen rider over a period of time which could indicate that the rider was injured or otherwise incapacitated. In the example, the SOS alert 102 is associated with the pen rider named John which occurred in pen 25. One should appreciate the utility associated with SOS alerts. Pen rider safety is facilitated through the SOS alert that pinpoints the location of the rider by GPS data location. Additional data can be displayed on the user interface 100 such as any unusual time or environmental condition data which further indicates that a pen rider may be injured.

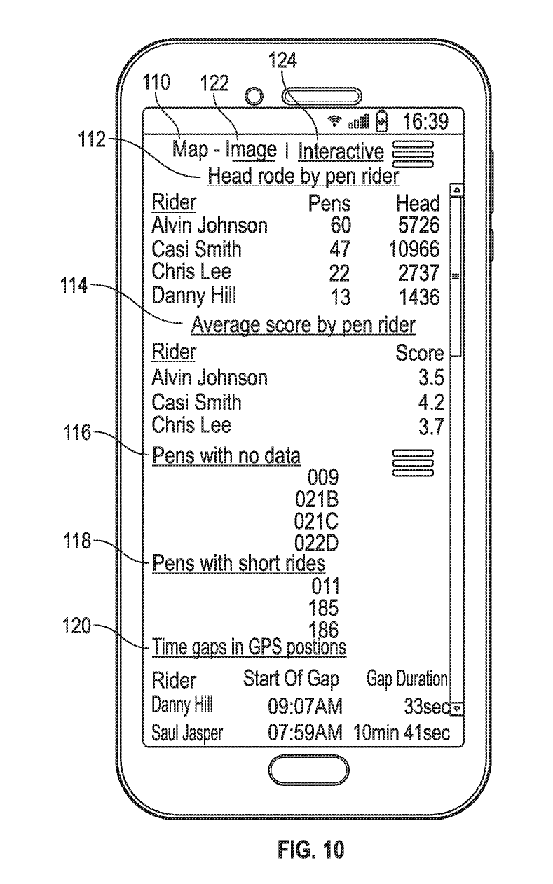

FIG. 10 is another sample user interface 110 showing a report that is generated to tabulate and summarize information regarding the performance of pen riders. The report tabulates data to include the number of head rode per pen rider, the average pen rider scores, pens with no data, pens with short rides, and out of range time gaps in GPS position data. The first field shown in the user interface is the data for the number of head and number of pens per rider on the day of the data transfer. Specifically, this first field 112 lists the name of the rider, the total number of pens ridden, and the total number of head in the pens. This data provides a useful overview of the activities of each rider and the number of animals that had to be observed. The next field shown is the average score of the pen riders 114. The score for each pen rider is shown which can be used for training purposes as discussed. The next field illustrated is the listing of pens with no data 116. This listing provides the same or additional details as the pen with no data field 46 referenced in FIG. 2. In the report of FIG. 10, additional information can be provided as to the reason why there is no data associated with the pens which could include no rides undertaken for the pen, no animals present in the pen, previous instructions that no rides should be undertaken within the pen, and others. The next field illustrated is the pens with short rides 118. This field provides the same or additional details as the pens with short rides field 48 referenced in FIG. 2. In the report of FIG. 10, additional information can also be provided as to the reason why short rides were recorded, such as a significantly fewer number of animals within the pen, no animals within the pen, etc. The last field illustrated is the time gaps in GPS positions field 120. This particular field provides information as to the identity of the rider, the start time of the gap in the transmission/receipt of GPS data, and the gap duration time. Gaps in GPS positions may signify a number of different events that could be occurring and which should either be remedied or otherwise evaluated. For example, the 33 second gap which commenced at 9:07 AM could be attributed to a temporary pause by the rider to evaluate a sick animal which required the rider to add identification of the animal in the Pulls user interface 62 by manipulating the GPS device for the corresponding data entry. For another example, the 10 min. 41 seconds gap which commenced at 7:59 AM could be attributed to a malfunction of the GPS device, a malfunction of the GPS receiver, or an SOS event when the rider was preoccupied with an emergency. In any event, the two occurrences listed in the field 120 provides a tool for further investigation and evaluation by pen rider personnel to determine what occurred at those time gaps and whether such time gaps were unavoidable.

From a review of the preceding user interfaces, it is clear that real-time GPS data is recorded and made available to system personnel to evaluate the character and quality of the pen rides undertaken by pen rider personnel. The captured GPS data is manipulated with the algorithms to automatically produce user displays with pen rider scores and other conclusive data which can be used to evaluate performance and to conduct training. Pen riders are free to conduct normal pen rider activities without the burden of significant data input and monitoring of the GPS devices which might otherwise preoccupy and distract the pen riders. The user interfaces can be incorporated directly within the GPS devices carried by the pen riders, or the user interfaces can be transmitted throughout the data processing system for observation used by all personnel.

The invention has been set forth herein with respect to preferred embodiments; however, it should be understood that the invention is not specifically limited to these preferred embodiments and should be viewed also in connection with the scope of the claims appended hereto.

What is claimed is:

1. A system for evaluating the quality of pen rider activities in an environment such as a feedlot comprising:
at least one GPS device carried by a pen rider as the pen rider moves through the feedlot, said GPS device recording a plurality of date and time stamps indicating geographic locations of the pen rider at corresponding times;
a computer processor communicating with the GPS device to receive data from the GPS device including the recorded date and time stamps;
said computer including at least one database for storing said data from said GPS device;
first programming instructions associated with the computer processor for determining the quality of at least one pen ride undertaken by the pen rider;
said programming instructions including at least one algorithm for determining a numerical score associated with the quality of the at least one pen ride, said algorithm having at least one measured factor that corresponds to a physical action of the pen rider; and
at least one user display automatically generated as associated with the computer processor to display at least one of (a) said numerical score for viewing by a system user or (b) a display of routes taken by the pen rider.

2. A system, as claimed in claim 1, wherein:
said at least one user display further includes said display of routes taken by the pen rider during times in which said GPS device recorded the plurality of date and time stamps.

3. A system, as claimed in claim 2, wherein:
said routes on said at least one user display further includes said routes superimposed over a graphical map of the feedlot or satellite imagery of the feedlot.

4. A system, as claimed in claim 1, wherein:
said measured factor includes at least one of a seconds paused score, a ride length score, a ride speed score, and a rotations score.

5. A system, as claimed in claim 4, wherein:
said measured factor is a plurality of measured factors, and said algorithm is a summation of said plurality of measured factors.

6. A system, as claimed in claim 1, further wherein:
data corresponding to locations and times of tagged animals in the feedlot is combined with data from said at least one GPS device to determine said numerical score.

7. A system, as claimed in claim 6, wherein:
said data of locations and times of tagged animals is incorporated in said algorithm to adjust said numerical score.

8. A system, as claimed in claim 1, further including:
second programming instructions associated with the computer processor for determining a pause taken by the pen rider

9. A method for evaluating the quality of pen rider activities in an environment such as a feedlot comprising:
providing at least one GPS device carried by a pen rider as the pen rider moves through the feedlot;
recording a plurality of date and time stamp data by said GPS device indicating locations of the pen rider at corresponding times;
transferring the data to a computer processor including the recorded date and time stamps;
executing programming instructions associated with the computer processor for determining the quality of at least one pen ride undertaken by the pen rider;
said programming instructions including at least one algorithm for determining a numerical score associated with the quality of the at least one pen ride, said algorithm having at least one measured factor that corresponds to a physical action of the pen rider; and
automatically generating an output from said computer processor including at least one user display to indicate said numerical score for viewing by a user.

10. A method, as claimed in claim 8, further including:
displaying routes taken by the pen rider during times in which said GPS device recorded the plurality of date and time stamps.

11. A method, as claimed in claim 9, wherein:
said routes on said at least one user display further includes said routes superimposed over a map of the feedlot or satellite imagery of the feedlot.

12. A method, as claimed in claim 1, wherein:
said measured factor includes at least one of a seconds paused score, a ride length score, a ride speed score, and a rotations score.

13. A method, as claimed in claim 11, wherein:
said measured factor is a plurality of measured factors, and said algorithm is a summation of said plurality of measured factors.

14. A method, as claimed in claim 1, further wherein:
data corresponding to locations and times of tagged animals in the feedlot is combined with data from said at least one GPS device to determine said numerical score.

15. A method, as claimed in claim 13, wherein:
said data of locations and times of tagged animals is incorporated in said algorithm to adjust said numerical score.

16. In sub-combination, a GPS device for recording pen rider activities and a user display for conveying information to a pen rider regarding recorded actions of the pen rider while conducting pen rider activities, comprising:
at least one GPS device carried by a pen rider as the pen rider moves through an environment such as a feedlot, said GPS device recording a plurality of date and time stamps indicating locations of the pen rider at corresponding times; and
at least one user display automatically generated, as associated with a computer processor, to display at least one of (a) a numerical score for viewing by a system user, the numerical score corresponding to a quality of the at least one pen ride as calculated by an algorithm processed by said computer processor, said algorithm having at least one measured factor that corresponds to a physical action of the pen rider or (b) a display of routes taken by the pen rider during times in which said GPS device recorded the plurality of date and time stamps, said routes displayed with a graphical map or satellite imagery of the environment.

17. In combination, a GPS device for recording pen rider activities and a non-transitory computer-readable medium containing computer executable instructions executed by a processor, the instructions causing the processor to execute a method for evaluating the quality of pen rider activities in an environment such as a feedlot, wherein GPS data is downloaded from the GPS device to a database associated with the processor, the method comprising:
at least one GPS device carried by a pen rider as the pen rider moves through the feedlot;
instructions to record date and time stamp data by said GPS device indicating locations of the pen rider at corresponding times;
instructions to transfer the date and time stamp data to the computer processor;
instructions to execute programming associated with the computer processor for determining the quality of at least one pen ride undertaken by the pen rider;
said programming instructions including at least one algorithm for determining a numerical score associated with the quality of the at least one pen ride, said algorithm having at least one measured factor that corresponds to a physical action of the pen rider; and
instructions to automatically generate an output from said computer processor including at least one user display to indicate said numerical score for viewing by a user.
